(19) United States
(12) Patent Application Publication
(10) Pub. No.: US 2017/0327311 A1
(43) Pub. Date: Nov. 16, 2017

(54) SYSTEM AND METHOD FOR WEIGHING CONTENTS OF ROLL-OFF CONTAINERS

(71) Applicants: Larry E. Koenig, Canal Winchester, OH (US); Mark E. Koenig, Pickerington, OH (US)

(72) Inventors: Larry E. Koenig, Canal Winchester, OH (US); Mark E. Koenig, Pickerington, OH (US)

(21) Appl. No.: 15/476,839

(22) Filed: Mar. 31, 2017

Related U.S. Application Data
(60) Provisional application No. 62/328,042, filed on Apr. 27, 2016.
(60) Provisional application No. 62/316,550, filed on Mar. 31, 2016.

(51) Int. Cl. B65F 1/14; B65D 90/48; B65D 88/12; G01G 19/52

(52) U.S. Cl. CPC B65F 1/1473; G01G 19/52; B65F 1/1452; B65D 88/12; B65D 90/48; B65F 2210/184

(57) ABSTRACT

A system or method comprising at least one lift system that is adapted to raise a container (e.g., roll-off container) off of the floor or ground to allow for the amount of material in the container to be determined. An example of a lift system may be comprised of at least one air lift bag (i.e., air bag, air bladder, or air spring), which may include or be in communication with a control system and/or other suitable processing system to facilitate the determination of the amount of material in the container. For example, a control system may be adapted to monitor the air pressure required to inflate each air lift bag to a certain threshold and/or another suitable parameter or measurement associated with the inflation (e.g., pressure differential) or position of each air lift bag and then use that information to calculate the weight of material in the container.

This application claims the priority benefit of U.S. Provisional Application No. 62/316,550, filed Mar. 31, 2016, and U.S. Provisional Application No. 62/328,042, filed Apr. 27, 2016, each of which is hereby incorporated by reference in its entirety.

### BACKGROUND AND SUMMARY OF THE INVENTION

Exemplary embodiments of the present invention relate generally to systems and methods for weighing the contents of roll-off containers. Roll-off containers are commonly designed to receive and transfer large volumes of trash and other waste material (e.g., manufacturing waste, factory waste, plant waste, construction waste, etc.). However, unless expressly stated otherwise, exemplary embodiments of the invention are not limited to a particular type of material to be weighed in the container. In addition, unless expressly stated otherwise, exemplary embodiments of the invention may be used in conjunction with other types of containers that are not of the roll-off variety.

Often in an effort to be more productive or to create improvements, there is a counter-result that more waste is also produced. For example, manufacturing sites, factories, and other plants are frequently operated at maximum capacity (e.g., 24 hours a day). In order to do so, a large volume of waste is also produced. Roll-off containers may be used to collect and remove that waste. However, roll-off containers are often not filled to capacity, which leads to an inefficient operation. For instance, pick-up schedules may be set in advance, and the roll-off containers may be removed when only partially-filled.

Due to the size and configuration of roll-off containers, it is difficult to determine how much material is in a roll-off container before it is removed to be dumped. There is therefore a need to be able to determine the amount of material in a roll-off container. Likewise, there is a need to be able to track the amount of material in a roll-off container as it is being filled. In addition, it is needed to be able to automatically or semi-automatically trigger a hauling or removal request once it is determined that the amount of material in a container has reached a certain threshold (e.g., substantially full). Finally, there is a need to be able to fulfill one or more of the aforementioned needs with a system that causes minimal disturbance to the existing facility.

Exemplary embodiments of a system and method of the present invention may satisfy at least one of the aforementioned needs. One exemplary embodiment may comprise at least one lift system that is adapted to raise a container (e.g., a roll-off container) off of the floor or ground to allow for the amount of material in the container to be determined. In one example, a lift system may be comprised of at least one air lift bag (i.e., air bag, air bladder, or air spring). In an exemplary embodiment, the use of at least one air lift bag may provide particular benefits such as, but not limited to, size, location of use, minimal disruption of the facility, means for activation, and/or means for operation, etc. However, some exemplary embodiments may include a different type of lift system.

While the container is lifted, the amount of material in the container may be determined. In an exemplary embodiment, the lift system(s) may include or otherwise be in communication with a control system and/or other suitable processing system to facilitate the determination of the amount of material in the container. For instance, in one embodiment that comprises at least one air lift bag, an exemplary embodiment of a control system and/or processing system may be adapted to monitor the air pressure required to inflate each air lift bag to a certain threshold and/or another suitable parameter or measurement associated with the inflation (e.g., pressure differential) or position of each air lift bag and then use that information to calculate the weight of the material in the container. Furthermore, an exemplary embodiment of a control system and/or processing system may be adapted to track the amount of material in the container as it is being filled. An exemplary embodiment of a control system and/or processing system may also be adapted to automatically or semi-automatically trigger a hauling or removal request once it is determined that the amount of material in a container has reached a certain threshold (e.g., substantially full).

In addition to the novel features and advantages mentioned above, other benefits will be readily apparent from the following descriptions of the drawings and exemplary embodiments.

### BRIEF DESCRIPTION OF THE DRAWINGS

FIG. 1 is a top plan view of one exemplary embodiment of a system of the present invention, additionally indicating a section line A-A.

FIG. 2 is a cross-sectional view along line A-A of FIG. 1, additionally indicating Detail B.

FIG. 3 is a view of Detail B of FIG. 2.

FIG. 4 is a side elevation view of the system of FIG. 1, additionally indicating a Detail C.

FIG. 5 is a view of Detail C of FIG. 4.

FIG. 6 is a perspective view of the system of FIG. 1.

FIG. 7 is a partial top plan view of the system of FIG. 1, wherein the exemplary embodiment of a roll-off container is not shown in order to expose an exemplary embodiment of a lift system. FIG. 7 also shows exemplary embodiments of a pump and a control system/processing system in association with the system of FIG. 1.

FIG. 8 is a perspective view of the partial system shown in FIG. 7.

FIG. 9 is a side elevation view of the partial system shown in FIG. 7.

FIG. 10 is a perspective, exploded view of a first exemplary embodiment of a lift system.

FIG. 11 is a perspective, exploded view of a second exemplary embodiment of a lift system.

FIG. 12 is a side elevation view of the lift system of FIG. 10 or 11 in a lowered (i.e., deflated) position.

FIG. 13 is a side elevation view of the lift system of FIG. 10 or 11 in a raised (i.e., inflated) position.

FIG. 14 is a perspective, exploded view of a third exemplary embodiment of a lift system.

FIG. 15 is a perspective, exploded view of a fourth exemplary embodiment of a lift system.

### DETAILED DESCRIPTION OF EXEMPLARY EMBODIMENT(S)

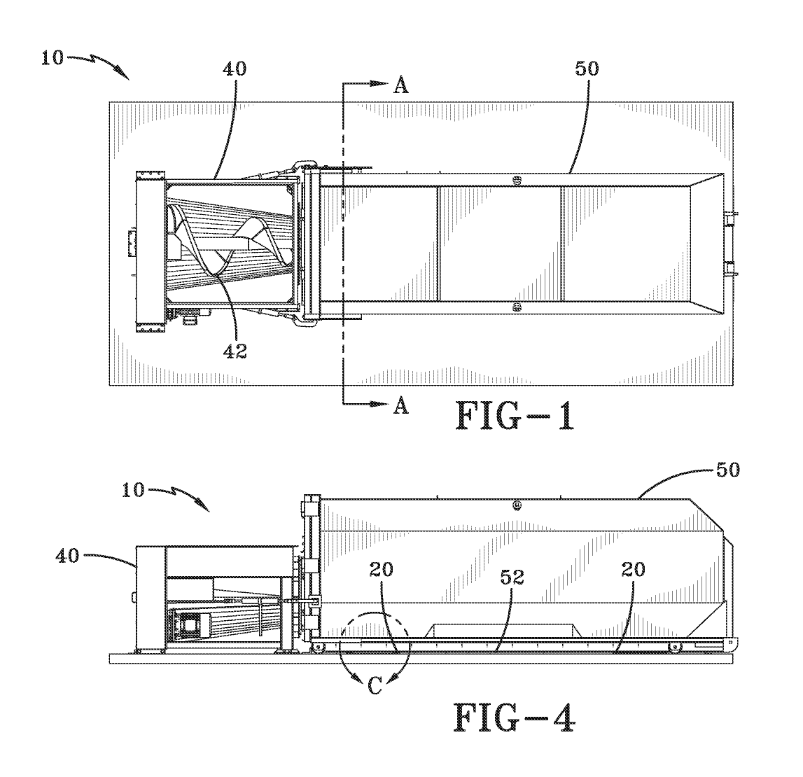

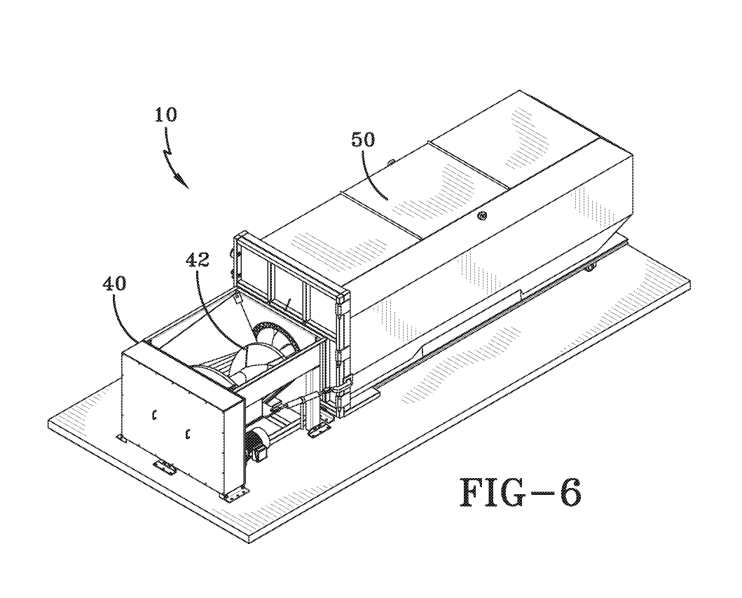

Exemplary embodiments of the present invention are directed to systems and methods for weighing the contents of containers such as roll-off containers. FIGS. 1-6 show one exemplary embodiment of a system 10 of the present invention. In this example, the system 10 is comprised of at least one lift system 20 (i.e., a lift/weigh platform), a material feed system 40 (e.g., an auger/compactor), and a container 50 (e.g., a roll-off container). In an example of the operation of the system 10, the material feed system 40 is adapted to feed material into the container 50, and the at least one lift system 20 is adapted to lift the container 50 in order to facilitate the determination of the amount of material in the container 50. However, other embodiments may be considered not to include a material feed system and/or a container.

Exemplary embodiments may be adapted for use with any suitable type of material feed system and/or container. In this example, an auger feeder 40 is used, which may also assist with compaction of the material. In particular, this exemplary embodiment of an auger feeder 40 may comprise a cantilevered screw 42. While such an embodiment is particularly useful, other types of screw feeders or material conveyors may be used. On the other hand, other types of containers may be used in some embodiments (e.g., open-bed containers, containers that are not adapted to roll, etc.). In this example, the container 50 is attached to the auger feeder 40 by at least one ratchet. However, in other embodiments, there may not be a secure connection between a material feed system and a container.

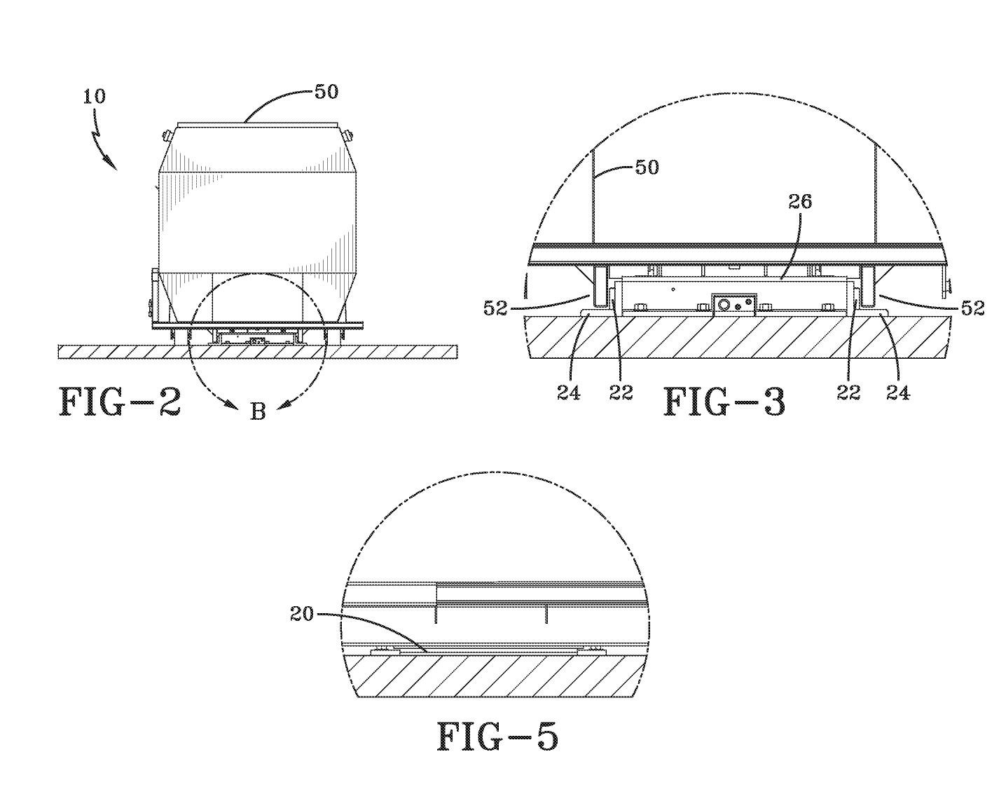

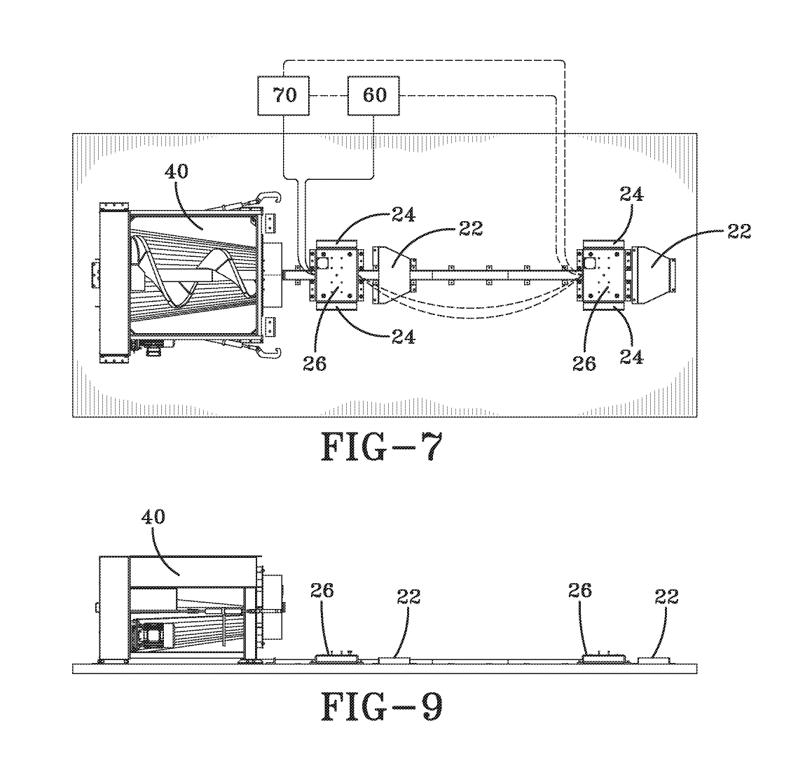

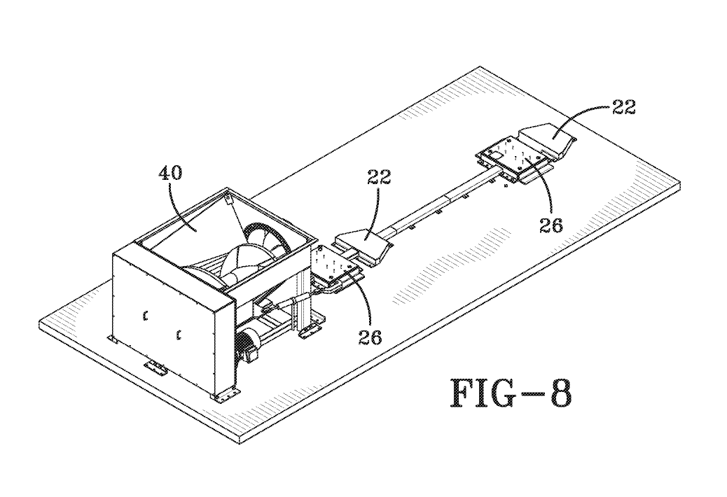

An exemplary embodiment of a roll-off container 50 typically comprises a pair of rails 52 that facilitate delivery and pick-up of the roll-off container 50. With respect to exemplary embodiments of a roll-off container 50, these rails 52 are commonly referred to as inner rails or outer rails. An exemplary embodiment of the present invention may be adapted to utilize the inner and/or outer rails 52 in order to facilitate the weighing process. For instance, in an exemplary embodiment, a lift system 20 may be sized and configured such that the rails 52 of the container 50 are adapted to be positioned on the at least one lift system 20 such that the at least one lift system 20 is able to lift the container 50. The use of the rails 52 may also help to ensure proper position of the container 50 such that an accurate determination may be made of the weight of the contents in the container 50. One example of this type of configuration is shown in FIG. 3. In particular, with further reference to FIGS. 7-15, an exemplary embodiment of a lift system 20 may include or otherwise be associated with at least one container guide 22 that helps to guide the container 50 into proper position such that rails 52 are respectively positioned on support flanges 24 of platform 26 of lift system 20. In this exemplary embodiment, each support flange 24 is situated below and extends distally away from an upper surface of the platform 26, which is particularly beneficial for stably supporting rails 52 of container 50. However, some embodiments of a lift system may not include a container guide or support flange. Furthermore, some embodiments may be adapted to lift a container without the benefit of a rail or rails or may be adapted to lift a container that does not include rails.

An exemplary embodiment may include any suitable number of lift systems to facilitate lifting and measurement of the contents of the container. The above-described examples include two lift systems 20. However, some embodiments may include additional lift systems or may include only one lift system.

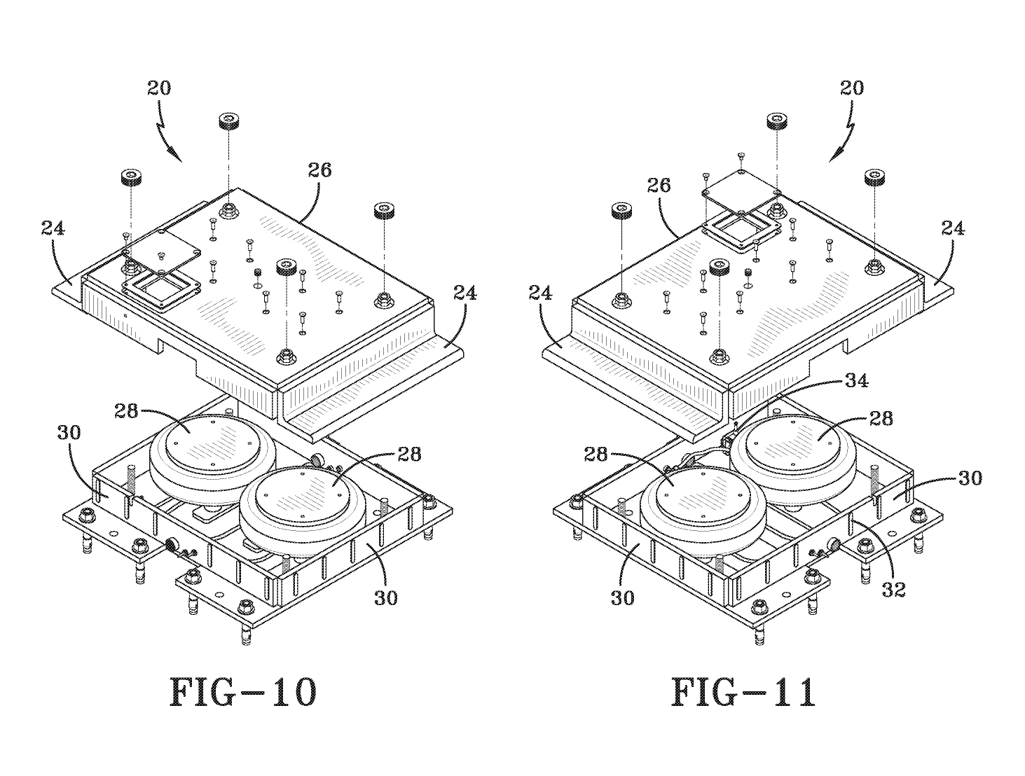

Exemplary embodiments of lift systems 20 are shown in FIGS. 10 and 11. An example of a lift system 20 may include at least one air lift bag 28 to facilitate lifting (e.g., raising and/or lowering) platform 26, which is configured to support container 50. In the examples of FIGS. 10 and 11, each lift system 20 is comprised of two air lift bags 28. One example of an air lift bag 28 may be available from Goodyear. In an exemplary embodiment, such as shown in FIG. 7, the air lift bag(s) 28 may be in fluid communication with at least one pump 60 to control the air pressure in the air lift bag(s) to raise or lower platform(s) 26 (and container 50), whereby measurement of the amount of material in a container may be facilitated. While a lift system comprising an air lift bag and pump may provide particular benefits such as, but not limited to, size, location of use, minimal disruption of the facility, means for activation, and/or means for operation, etc., other embodiments of the invention may implement a different type of lift system.

In each of the exemplary embodiments of FIGS. 10 and 11, a lift system 20 may comprise a base having at least one upwardly extending stave 30 that may include guide bushings 32, wherein the stave(s) 30/guide bushing(s) 32 may assist with the stability of the lift system 20 (e.g., by facilitating alignment of platform 26 with the base as platform 26 is raised or lowered relative to the base by air lift bag(s) 28). For example, at least one stave 30 may extend completely around the air lift bag(s) to enhance stability. In addition, such as shown in FIG. 11, an example of a lift system 20 may also include at least one measurement device 34 that is adapted to measure at least one parameter associated with an inflation level or position of an air lift bag 28 or air lift bags 28. A measurement device is not readily visible in the viewing angle shown in FIG. 10. Exemplary embodiments of measurement device 34 may include, but are not limited to, a string potentiometer (i.e., string pot), a linear position sensor, or another suitable position system to monitor the position of the air lift bag(s). One example of a string potentiometer may be accurate to thousandths of an inch, which may facilitate accuracy of the system.

Such as shown in FIG. 7, an exemplary embodiment of a lift system 20 may include or otherwise be in communication with at least one control system and/or processing system 70 that may be in communication with at least one measurement device 34 (e.g., in one or more lifting systems) and/or at least one pump 60 (which may also be included in or otherwise in communication with lift system 20). Additionally or alternatively, a pump may have an internal control system. For example, at least one control system and/or processing system 70 and/or an internal control system of pump 60 may assist with control of the range of motion of the air lift bag(s) 28. In an exemplary embodiment, at least one pump 60 that is in communication with at least one control system and/or processing system 70 and/or an internal control system may inflate the air bag(s) 28 until a certain threshold is reached as detected by at least one measurement device 34. The air lift bag(s) 28 may then deflate or compress as material is loaded into the container 50. When the at least one air lift bag 28 reaches a lower threshold as detected by the at least one measurement device 34, the at least one control system and/or processing system 70 and/or an internal control system may cause the pump to re-inflate the at least one air lift bag 28 to the aforementioned upper threshold or another desired threshold. This process may be repeated until it is determined that the container 50 is filled to a desired level (e.g., substantially full). As a result, for example, the at least one control system and/or processing system 70 and/or an internal pump control system may be adapted to monitor the air pressure required to inflate each air lift bag 28 to a certain threshold and/or another suitable parameter or measurement associated with the inflation (e.g., a pressure differential) or position of each air lift bag 28 and then use that information to calculate the weight of material in the container 50.

An exemplary embodiment of at least one control system and/or processing system 70 may be adapted to track the amount of material in the container 50 as it is being filled. Once it is determined that the amount of material in a container 50 has reached a certain threshold, an exemplary embodiment of at least one control system and/or processing system 70 may also be adapted to automatically or semi-automatically trigger a hauling or removal request. While the aforementioned examples may be particularly beneficial, other exemplary embodiments may include other components and/or means to monitor the operation of a lift system 20 and determine the amount of material in a container 50.

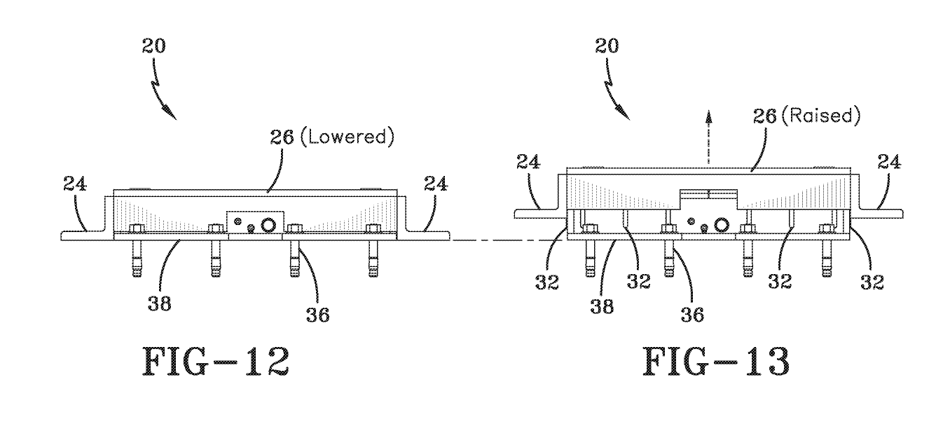

FIGS. 12 and 13 show different positions of an exemplary embodiment of a lift system 20. FIG. 12 shows the platform 26 of lift system 20 in a lowered (i.e., deflated) position, wherein FIG. 13 shows the lift system 20 in a raised (i.e., inflated) position. Also, as can be seen, an exemplary embodiment of a lift system 20 may be mounted with only anchor bolts 36 through base 38, which may only cause minimal disturbance to an existing facility. Other exemplary embodiments may have a different configuration that facilitates the desired operation. For example, while the aforementioned embodiments are particularly beneficial wherein the air lift bag(s) are positioned between the platform 26 and the base 38 of the lift system 20, other configurations may be possible.

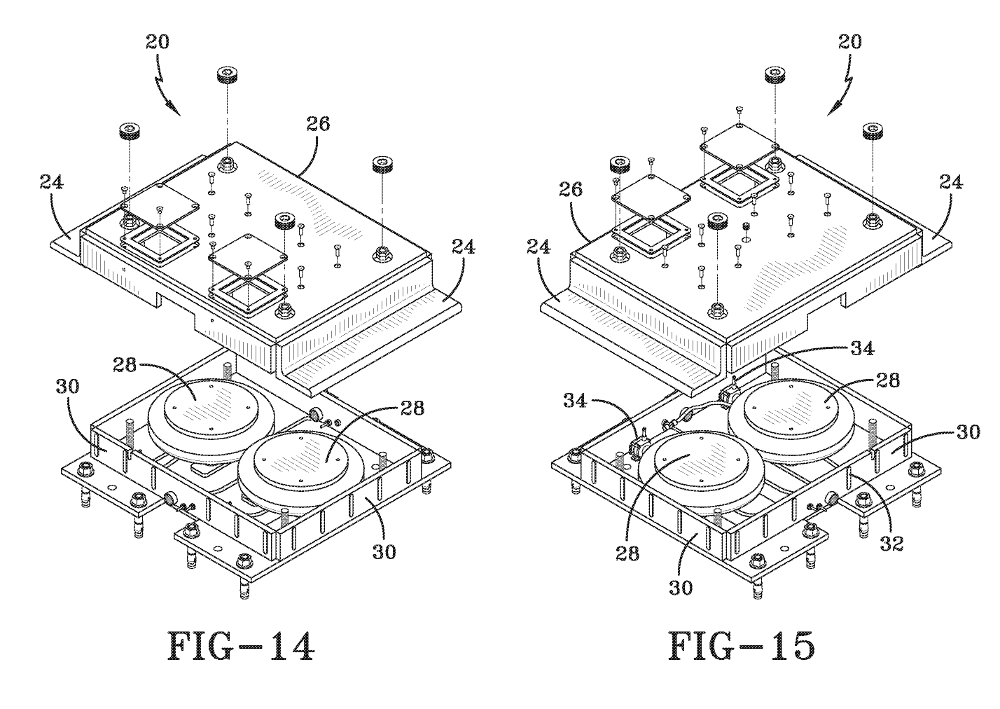

FIGS. 14 and 15 show other exemplary embodiments of lift systems of the present invention. In these exemplary embodiments, each air spring 28 is associated with a respective measurement device 34, which may each be in communication with at least one control and/or processing system 70 and/or an internal pump control system. As a result, such embodiments may enable the air pressure of each air spring 28 to be independently controlled. An exemplary embodiment of the enhanced control may allow for improved accuracy of the weighing system 10 and/or improved stability of the lift platform 26 (e.g., by maintaining a more even inflation level of the air spring(s) 28 in the platform(s)). The operation and configuration of these exemplary embodiments may otherwise be similar to the other described exemplary embodiments of the present invention.

In the above examples, each lift system 20 includes two air springs 28, wherein each air spring 28 is associated with a measurement device 34. While the above-described embodiments may provide particularly beneficial results, exemplary embodiments may include any desired number of lift systems, air springs, platforms, or measurement devices. For example, as previously noted, some exemplary systems may include only a single air spring in a platform or only a single platform (with one or more air springs). In addition, other exemplary systems may include three or more air springs in a platform or three or more platforms (each with one or more air springs).

Likewise, as previously mentioned, a system may include at least one pump and at least one control system and/or processing system. One exemplary embodiment may include a pump with multiple outlets. For example, each air spring in a platform may be in communication with an independent air line from the pump. For instance, in a system with multiple platforms, a pump with multiple outlets may provide independent air lines directly to each of the platforms. Alternatively, an exemplary embodiment of a platform (e.g., see the platforms of FIGS. 10 and 14) may be configured to receive independent lines from at least one pump and then provide independent lines to another platform (i.e., daisy chain multiple platforms). In other exemplary embodiments, an air line from a pump may be diverted to multiple air springs. Other embodiments may include multiple pumps, each with one or more outlets. For example, each air spring and/or platform may be in communication with a different pump. Other exemplary configurations are also possible for directing air to a spring and/or platform.

Any embodiment of the present invention may include any of the optional or preferred features of the other embodiments of the present invention. The exemplary embodiments herein disclosed are not intended to be exhaustive or to unnecessarily limit the scope of the invention. The exemplary embodiments were chosen and described in order to explain some of the principles of the present invention so that others skilled in the art may practice the invention. Having shown and described exemplary embodiments of the present invention, those skilled in the art will realize that many variations and modifications may be made to the described invention. Many of those variations and modifications will provide the same result and fall within the spirit of the claimed invention.

What is claimed is:

1. A system for measuring an amount of material in a container, said system comprising:
a lift system comprising:
(i) an air lift bag;
(ii) a platform that is adapted to be raised or lowered by said air lift bag, said platform adapted to support a container; and
(iii) a measurement device adapted to measure at least one parameter associated with an inflation level or position of said air lift bag;
a pump adapted to control an air pressure in said air lift bag to raise or lower said platform; and
a processing system in communication with said measurement device such that said processing system is adapted to use said at least one parameter to determine an amount of material in said container.

2. The system of claim 1 wherein said lift system further comprises at least one additional air lift bag such that said platform is adapted to be raised or lowered by said air lift bag and said at least one additional air lift bag.

3. The system of claim 2 further comprising at least one additional measurement device respectively adapted to measure at least one parameter associated with an inflation level or position of each said additional air lift bag.

4. The system of claim 3 wherein said processing system is in communication with each said additional measurement device such that said processing system is adapted to use each said measured parameter to determine an amount of material in said container.

5. The system of claim 2 wherein said pump is further adapted to control an air pressure in said at least one additional air lift bag to raise or lower said platform.

6. The system of claim 1 further comprising at least one additional lift system respectively comprising:
an air lift bag;
a platform that is adapted to be raised or lowered by said air lift bag, said platform adapted to support said container; and
a measurement device adapted to measure at least one parameter associated with an inflation level or position of said air lift bag;
wherein said processing system is in communication with each said additional lift system such that said processing system is adapted to use each said measured parameter to determine an amount of material in said container.

7. The system of claim 6 wherein said pump is further adapted to respectively control an air pressure in said air lift bag to raise or lower said platform of said at least one additional lift system.

8. The system of claim 1 wherein said lift system further comprises a base such that said air lift bag is positioned between said base and said platform, said base comprising at least one upwardly extending stave to facilitate aligning said platform with said base.

9. The system of claim 8 wherein said at least one stave extends substantially completely around said air lift bag.

10. The system of claim 1 wherein said platform further comprises at least one support flange situated below and extending distally away from an upper surface of said platform such that said at least one support flange is adapted to support said container.

11. The system of claim 1 wherein said measurement device is a string potentiometer.

12. The system of claim 1 wherein said measurement device is a linear position sensor.

13. A system for measuring an amount of material in a container, said system comprising:
a container;
a lift system comprising:
(i) an air lift bag;
(ii) a platform supporting said container, said platform and said container adapted to be raised or lowered by said air lift bag; and
(iii) a measurement device adapted to measure at least one parameter associated with an inflation level or position of said air lift bag;
a pump adapted to control an air pressure in said air lift bag to raise or lower said platform and said container; and
a processing system in communication with said measurement device such that said processing system is adapted to use said at least one parameter to determine an amount of material in said container.

14. The system of claim 13 wherein said lift system further comprises at least one additional air lift bag such that said platform and said container are adapted to be raised or lowered by said air lift bag and said at least one additional air lift bag.

15. The system of claim 14 further comprising at least one additional measurement device respectively adapted to measure at least one parameter associated with an inflation level or position of each said additional air lift bag.

16. The system of claim 15 wherein said processing system is in communication with each said additional measurement device such that said processing system is adapted to use each said measured parameter to determine an amount of material in said container.

17. The system of claim 14 wherein said pump is further adapted to control an air pressure in said at least one additional air lift bag to raise or lower said platform and said container.

18. The system of claim 13 further comprising at least one additional lift system respectively comprising:
an air lift bag;
a platform supporting said container, said platform and said container adapted to be raised or lowered by said air lift bag; and
a measurement device adapted to measure at least one parameter associated with an inflation level or position of said air lift bag;
wherein said processing system is in communication with each said additional lift system such that said processing system is adapted to use each said measured parameter to determine an amount of material in said container.

19. The system of claim 18 wherein said pump is further adapted to respectively control an air pressure in said air lift bag to raise or lower said platform of said at least one additional lift system and said container.

20. The system of claim 13 wherein said lift system further comprises a base such that said air lift bag is positioned between said base and said platform, said base comprising at least one upwardly extending stave to facilitate aligning said platform with said base.

21. The system of claim 20 wherein said at least one stave extends substantially completely around said air lift bag.

22. The system of claim 13 wherein said platform further comprises at least one support flange situated below and extending distally away from an upper surface of said platform such that said at least one support flange supports said container.

23. The system of claim 22 wherein:
said container is a roll-off container comprising a pair of rails; and
said platform comprises a pair of said support flanges such that said support flanges respectively support said rails of said roll-off container.

24. The system of claim 13 wherein said container is a roll-off container.

25. The system of claim 13 wherein said measurement device is a string potentiometer.

26. The system of claim 13 wherein said measurement device is a linear position sensor.

27. A system for measuring an amount of material in a container, said system comprising:
an auger feeder adapted to feed material into a container;
a lift system comprising:
(i) an air lift bag;
(ii) a platform that is adapted to be raised or lowered by said air lift bag, said platform adapted to support said container; and
(iii) a measurement device adapted to measure at least one parameter associated with an inflation level or position of said air lift bag;
a pump adapted to control an air pressure in said air lift bag to raise or lower said platform; and
a processing system in communication with said measurement device such that said processing system is adapted to use said at least one parameter to determine an amount of material in said container.

28. The system of claim 27 wherein said lift system further comprises at least one additional air lift bag such that said platform is adapted to be raised or lowered by said air lift bag and said at least one additional air lift bag.

29. The system of claim 28 further comprising at least one additional measurement device respectively adapted to measure at least one parameter associated with an inflation level or position of each said additional air lift bag.

30. The system of claim 29 wherein said processing system is in communication with each said additional measurement device such that said processing system is adapted to use each said measured parameter to determine an amount of material in said container.

31. The system of claim 28 wherein said pump is further adapted to control an air pressure in said at least one additional air lift bag to raise or lower said platform.

32. The system of claim 27 further comprising at least one additional lift system respectively comprising:
an air lift bag;
a platform that is adapted to be raised or lowered by said air lift bag, said platform adapted to support said container; and
a measurement device adapted to measure at least one parameter associated with an inflation level or position of said air lift bag;
wherein said processing system is in communication with each said additional lift system such that said processing system is adapted to use each said measured parameter to determine an amount of material in said container.

33. The system of claim 32 wherein said pump is further adapted to respectively control an air pressure in said air lift bag to raise or lower said platform of said at least one additional lift system.

34. The system of claim 27 wherein said lift system further comprises a base such that said air lift bag is positioned between said base and said platform, said base comprising at least one upwardly extending stave to facilitate aligning said platform with said base.

35. The system of claim 34 wherein said at least one stave extends substantially completely around said air lift bag.

36. The system of claim 27 wherein said measurement device is a string potentiometer.

37. The system of claim 27 wherein said measurement device is a linear position sensor.
